(19) United States
(12) Patent Application Publication
(10) Pub. No.: US 2013/0054218 A1
(43) Pub. Date: Feb. 28, 2013

(54) Method and Software Tool for Automatically Testing a Circuit Design

(71) Applicant: Ameen Ashraf, Santa Clara, CA (US)

(72) Inventor: Ameen Ashraf, Santa Clara, CA (US)

(21) Appl. No.: 13/216,682

(22) Filed: Aug. 24, 2011

(51) Int. Cl. G06F 17/50

(52) U.S. Cl. 703/14

(57) ABSTRACT

A software tool and method for performing a simulation of a circuit to automatically test a circuit design are disclosed. A series of primary transactions may be performed on the circuit under test. Resources in the circuit may be monitored to identify the state changes, and a set of new transactions to perform on the circuit may be automatically generated based on the state changes of the resources. The new transactions may then be performed on the circuit. The new transactions that are generated may not be pre-determined transactions, but rather may be transactions that are dynamically generated or learned during the simulation, e.g., in an intelligent manner.

### BACKGROUND

1. Field of the Invention

This application is related to the field of circuit design, and more particularly to a software tool and method for automatically testing a circuit design.

2. Description of the Related Art

Circuit simulation is the use of computer programs to simulate the operation of a circuit. Circuit simulation is a useful tool used for verifying the logical correctness of a circuit design before actually building the circuit in hardware. Simulating a circuit's behavior before actually building it can greatly improve design efficiency by making faulty designs known and providing insight into the circuit's behavior.

In a digital circuit design, register transfer level (RTL) is a level of abstraction used in describing the operation of a synchronous digital circuit. In RTL design, a circuit's behavior is defined in terms of the flow of signals or transfer of data and the logical operations performed on those signals. Hardware description languages (HDLs) such as Verilog and VHDL may be used to create high-level representations of a digital circuit, from which lower-level representations and ultimately actual wiring can be derived. Design at the RTL level is a typical practice in modern digital circuit design.

### SUMMARY

Various embodiments of a software tool and method for performing a simulation of a circuit to automatically test a circuit design are disclosed herein. The software tool and method may operate to perform a series of primary transactions on the circuit under test. Each primary transaction may be performed by providing one or more respective inputs to the circuit. The input(s) may cause the circuit to perform an operation and generate output. The output from the circuit may be checked to determine whether the circuit produced expected output.

The circuit may include various resources, such as status bits or registers, arbiters or arbitration logic, state machines, FIFO (first-in first-out) queues, counters, etc. These resources may undergo state changes in response to the primary transactions. The method and software tool may operate to monitor the resources in the circuit to identify the state changes, and to automatically determine a set of new transactions to perform on the circuit based on the state changes of the resources. The new transactions may then be performed on the circuit.

The primary transactions that are performed may be pre-determined transactions. For example, the software tool may be programmed to perform a known series of primary transactions, e.g., where the developer of the software tool pre-programmed or pre-configured the software tool with those particular transactions prior to executing the software tool to test the circuit. Based on the state changes of the resources, the software tool may automatically generate new transactions to further test the circuit. The new transactions that are generated may not be pre-determined transactions that the software tool was already configured to perform prior to beginning the simulation, but rather may be transactions that are dynamically generated or learned during the simulation, e.g., in an intelligent manner. By monitoring state changes of the circuit resources that are caused by the pre-determined primary transactions, the software tool may be able to use an algorithm or heuristic to automatically generate or determine new transactions that will increase the utilization of the circuit resources or place the resources in new states so as to better test the circuit.

### BRIEF DESCRIPTION OF THE DRAWINGS

The following detailed description makes reference to the accompanying drawings, which are now briefly described.

FIG. 1 illustrates an example of a computer system configured to execute simulation software that implements a simulation environment for testing a circuit;

FIG. 2 is a more detailed illustration of the computer system according to one embodiment;

FIG. 3 is a flowchart diagram illustrating one embodiment of a method for performing a simulation of the circuit under test;

FIG. 4 illustrates an example set of primary transactions that may be performed during the simulation;

FIGS. 5-12 illustrate examples of new transactions that may be automatically generated by the simulation software based on the primary transactions and based on state changes of resources in the circuit; and

FIG. 13 is a block diagram of a computer accessible storage medium that stores program instructions implementing the simulation software.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims. The headings used herein are for organizational purposes only and are not meant to be used to limit the scope of the description. As used throughout this application, the word “may” is used in a permissive sense (i.e., meaning having the potential to), rather than the mandatory sense (i.e., meaning must). Similarly, the words “include”, “including”, and “includes” mean including, but not limited to.

Various units, circuits, or other components may be described as “configured to” perform a task or tasks. In such contexts, “configured to” is a broad recitation of structure generally meaning “having circuitry that” performs the task or tasks during operation. As such, the unit/circuit/component can be configured to perform the task even when the unit/circuit/component is not currently on. In general, the circuitry that forms the structure corresponding to “configured to” may include hardware circuits and/or memory storing program instructions executable to implement the operation. The memory can include volatile memory such as static or dynamic random access memory and/or nonvolatile memory such as optical or magnetic disk storage, flash memory, programmable read-only memories, etc. Similarly, various units/circuits/components may be described as performing a task or tasks, for convenience in the description. Such descriptions should be interpreted as including the phrase “configured to.” Reciting a unit/circuit/component that is configured to perform one or more tasks is expressly intended not to invoke 35 U.S.C. §112, paragraph six interpretation for that unit/circuit/component.

### DETAILED DESCRIPTION OF EMBODIMENTS

Various embodiments of a software tool and method for performing a simulation of a circuit to automatically test a circuit design are described herein. The circuit being simulated is referred to herein as “the circuit under test” or simply “the circuit”. These terms refer to a computer model of the circuit, e.g., since the purpose of the simulation may be to test the design of the circuit before actually building the circuit.

The circuit under test may be a digital circuit. In some embodiments the circuit may be an integrated circuit (IC) or system-on-a-chip (SoC). In other embodiments the circuit may be a component or sub-circuit used in a chip or other larger circuit. As one example, the circuit may implement a memory controller used in a chip. The circuit may be used in any type of system or product. For example, in some embodiments the circuit may be used in a mobile phone or other handheld electronic device.

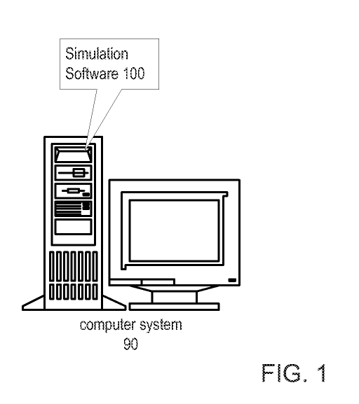

FIG. 1 illustrates an example of a computer system 90 configured to execute simulation software 100, which implements a simulation environment for testing the circuit. In various embodiments the circuit may be simulated at various levels of abstraction, such as a gate level, register transfer level (RTL), or behavioral (or algorithmic) level simulation. In some particular embodiments the circuit may be simulated at the register transfer level, e.g., where the circuit is modeled or represented using a hardware description language (HDL) such as Verilog or VHDL.

The circuit under test may have an input interface that defines input values that the circuit can receive, such as commands or signals received via one or more input ports that instruct or cause the circuit to perform various operations. For example, the input values may represent commands or operations such as “reset”, “read”, “write”, “clear”, “start”, “wait”, “stop”, etc. The input values may also represent data or parameters passed to the circuit along with the commands, such as the data to be written in a write operation, for example. In various embodiments the input interface may define any of various kinds of input values or signals that are valid for the circuit to receive, e.g., depending on the kind of circuit.

The circuit may also have an output interface that defines output values or signals that are generated via one or more output ports in response to the input values.

For example, the circuit may receive an input command via an input port, perform an operation specified by the input command, and generate one or more output values via the output ports. For example, an output value may indicate a status of the operation that was performed, such as whether it succeeded or failed. As another example, an output value may represent a signal or command generated by the circuit in response to the operation, where the signal or command can then be provided to another circuit or device. In various embodiments the output interface may define any of various kinds of output values or signals that can be generated by the circuit, e.g., depending on the kind of circuit.

The simulation software 100 may execute on the computer system 90 to test the circuit by providing input values to the circuit and checking the output values produced in response to the input. More particularly, the simulation software 100 may perform a series of transactions, where each transaction is performed by providing a set of one or more input values to the circuit and checking a set of one or more output values produced by the circuit, e.g., to determine whether the circuit produced the output values that were expected. In some embodiments each transaction may correspond to a clock cycle of a digital circuit, e.g., where the input values for a particular transaction represent input provided to the digital circuit during a particular clock cycle, and the output values for the transaction represent output produced by the digital circuit during the clock cycle. Alternatively or in addition, a transaction may correspond to multiple clock cycles, with inputs provided on various clock cycles and outputs generated on various clock cycles.

The simulation software 100 may be programmed to perform a known series of primary transactions, e.g., where the developer of the simulation software 100 pre-programmed or configured the simulation software 100 with those particular transactions prior to executing the simulation software 100 to test the circuit. The simulation software 100 may monitor internal resources of the circuit while the primary transactions are performed to determine state changes of the resources. Based on the state changes of the resources, the simulation software 100 may automatically generate new transactions to further test the circuit. The new transactions that are generated may not be pre-determined transactions that the simulation software 100 was already configured to perform prior to beginning the simulation, but rather may be transactions that are dynamically generated or learned during the simulation in an intelligent manner. By monitoring state changes of the circuit resources that are caused by the pre-determined primary transactions, the simulation software 100 may be able to use an algorithm or heuristic to automatically generate or determine new transactions that will increase the utilization of the circuit resources or place the resources in new states so as to better test the circuit. Thus, some embodiments of the method and software tool described herein may increase the efficiency for testing a circuit design by automatically generating new transactions to test the circuit design that a human circuit designer would not have thought of performing, or by generating new transactions that more quickly achieve a desired measure of test coverage.

In various embodiments the simulation software 100 may execute on any kind of computer system 90, such as a personal computer system (PC), workstation, network appliance, distributed computer system, handheld device, or other computing device or combinations of devices. In general, the term “computer system” can be broadly defined to encompass any device (or combination of devices) having at least one processor that executes instructions from one or more storage mediums.

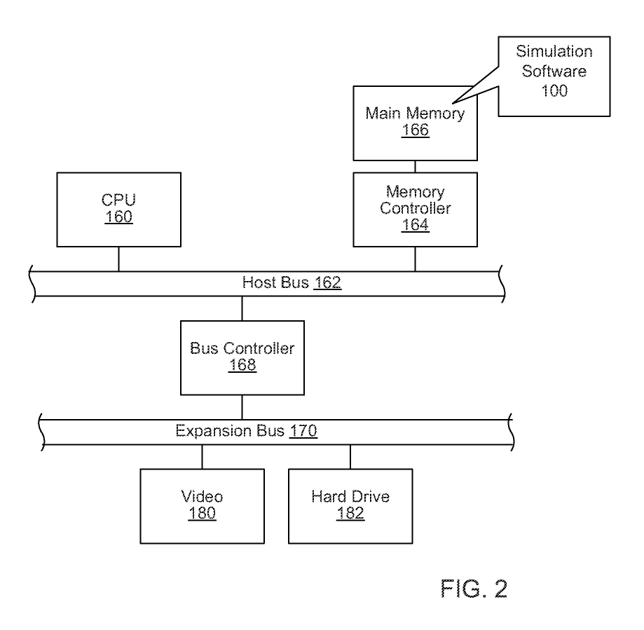

FIG. 2 is a more detailed illustration of the computer system 90 according to one embodiment. It is noted that in other embodiments the computer system 90 may have any other configuration or architecture, and FIG. 2 illustrates a representative PC embodiment. It is also noted that the computer system 90 may be a general purpose desktop computer system, a computer implemented on a card installed in a chassis, or other types of embodiments. Elements of a computer not necessary to understand the present description have been omitted for simplicity.

The computer system 90 may include at least one central processing unit or CPU (processor) 160 which is coupled to a processor or host bus 162. The CPU 160 may be any of various types. For example, in some embodiments, the processor 160 may be compatible with the x86 architecture, while in other embodiments the processor 160 may be compatible with the SPARC™ family of processors. Also, in some embodiments the computer system 90 may include multiple processors 160.

The computer system 90 may also include memory 166 in which program instructions implementing the simulation software 100 are stored. In some embodiments the memory 166 may include one or more forms of random access memory (RAM) such as dynamic RAM (DRAM) or synchronous DRAM (SDRAM). In other embodiments, the memory 166 may include any other type of memory configured to store program instructions. The memory 166 may also store operating system software or other software used to control the operation of the computer system 90. The memory controller 164 may be configured to control the memory 166.

The host bus 162 may be coupled to an expansion or input/output bus 170 by means of a bus controller 168 or bus bridge logic. The expansion bus 170 may be the PCI (Peripheral Component Interconnect) expansion bus, although other bus types can be used. Various devices may be coupled to the expansion or input/output bus 170, such as a hard disk drive 182 which stores information in a non-volatile manner, as well as a video display subsystem 180 which sends video signals to a display device.

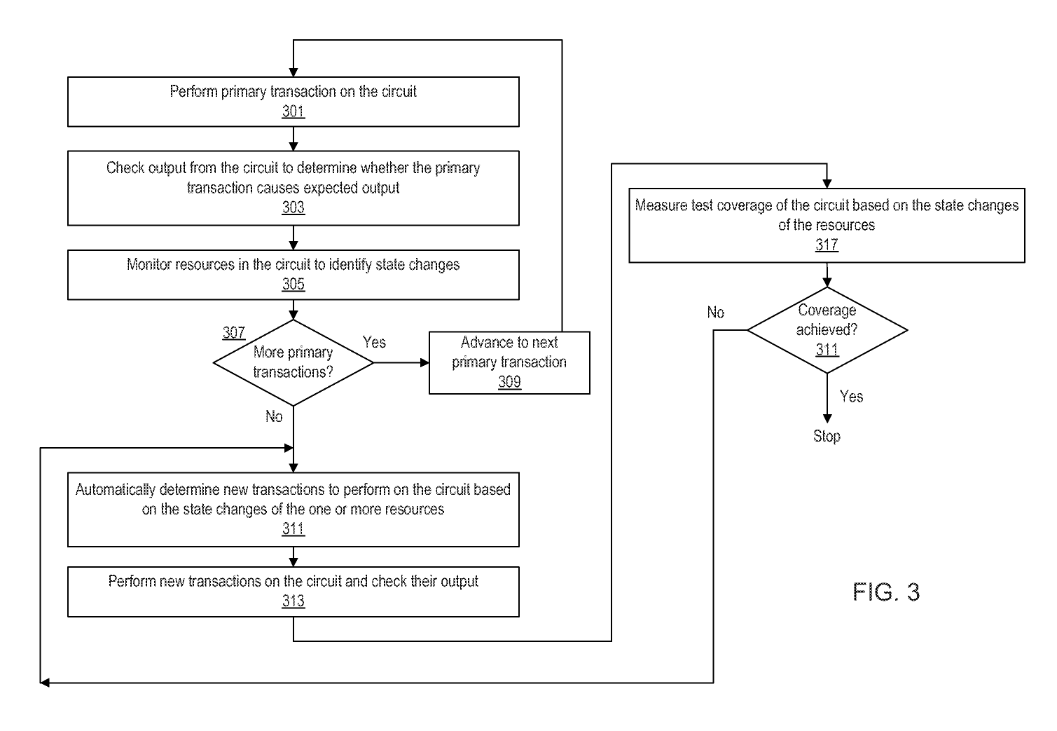

FIG. 3 is a flowchart diagram illustrating one embodiment of a method for performing a simulation of the circuit under test. The method may be implemented by the simulation software 100 executing on the computer system 90. As discussed above, the simulation software 100 may be pre-configured to perform a series of primary transactions on the circuit. In block 301 the simulation software may perform the first primary transaction by sending input to the circuit, e.g., one or more input values or signals that represent commands and/or data. The circuit under test may receive the input, perform an operation specified by the input, and produce one or more output values or signals that specify the results of the operation. In block 303 the simulation software 100 may check the output produced by the circuit to determine whether the primary transaction caused the expected output, e.g., to test the output for correctness.

As indicated in block 305, the simulation software may also monitor one or more resources in the circuit to identify state changes in them, e.g., in order to determine how the primary transactions affect the circuit. For example, the model of the circuit may include code, logic, or data structures representing the resources, and the simulation software 100 may include instrumentation code that monitors the resources to detect state changes. As discussed below, the simulation software 100 may automatically determine new transactions to perform on the circuit based on the state changes detected in the monitored resources.

In various embodiments, any kind of resources internal to the circuit may be monitored, e.g., depending on the kind of circuit being tested. Examples of circuit resources include status bits or registers, arbiters or arbitration logic, state machines, FIFO (first-in first-out) queues, counters, etc. In some embodiments the simulation software 100 may monitor a resource to determine state changes that indicate changes in the level of activity or level of utilization of the resource. For example, if the resource is an arbiter, the simulation software 100 may monitor the arbiter to determine whether it changes from an idle state to a busy state. As another example, if the resource is a FIFO queue, the simulation software 100 may monitor it to determine when a new item is added to the queue, or when the queue becomes full. As another example, the simulation software 100 may monitor a state machine resource in the circuit to detect when the state machine changes to different states.

As indicated in block 307, after the current primary transaction has been performed, the simulation software 100 may determine whether there are any other primary transactions left that still need to be performed. For example, the simulation software 100 may be configured with a list or table of primary transactions and may check whether all of the specified primary transactions have been performed. If not then in block 309 the simulation software 100 may advance to the next primary transaction and repeat the functions described above.

As indicated in block 311, once the primary transactions have been performed, the simulation software 100 may automatically determine a set of new transactions to perform on the circuit based on the state changes of the circuit resources that were detected when monitoring the resources. The simulation software 100 may automatically determine each new transaction by automatically determining one or more input values or signals that should be provided to the circuit, e.g., in order to cause the circuit to perform a particular operation. In some embodiments the simulation software 100 may also automatically determine the expected output that the circuit should generate in response to the input for each transaction.

The new transactions may not be transactions that are pre-determined in advance of the simulation, but rather may be ones that are automatically generated or determined dynamically during the simulation based on the resource state changes that were detected when monitoring the effects of the primary transactions. For example, the simulation software 100 may monitor the circuit resources to determine when a primary transaction (or set of primary transactions) causes a resource to change into an uncommon state or into a state that indicates a high level of activity or utilization. When the simulation software 100 finds such a primary transaction (or set of primary transactions), the simulation software 100 may automatically generate one or more new transactions to attempt to replicate the state change, or to further increase the utilization of the resource, or to further test the resource. Thus, the new transactions that are generated may be based on both the state changes of the circuit resources and the primary transactions.

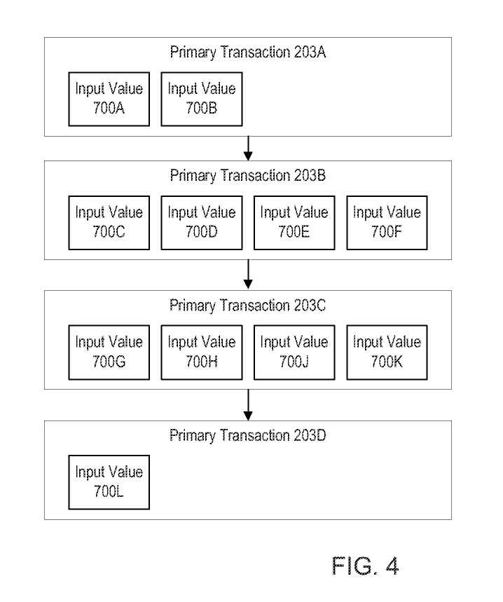

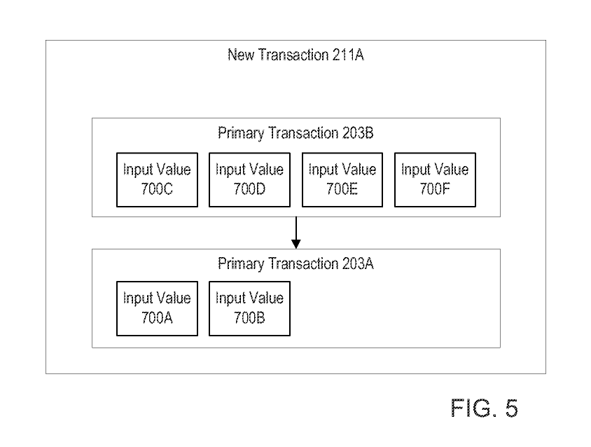

FIG. 4 illustrates an example set of four primary transactions 203 that may be performed during the simulation, e.g., where the primary transaction 203A is followed by the primary transaction 203B, and so on. FIGS. 5-12 illustrate examples of new transactions 211 that may be automatically generated by the simulation software 100 based on the primary transactions of FIG. 4. In some embodiments one or more of the new transactions generated by the simulation software 100 may be “meta-transactions” that combine two or more transactions. FIG. 5 illustrates an example of a new transaction 211A that combines the primary transactions 203A and 203B, but where their order has been changed so that the primary transaction 203B is performed before the primary transaction 203A. Thus, in some embodiments the new transactions generated by the simulation software 100 may change the order of the primary transactions.

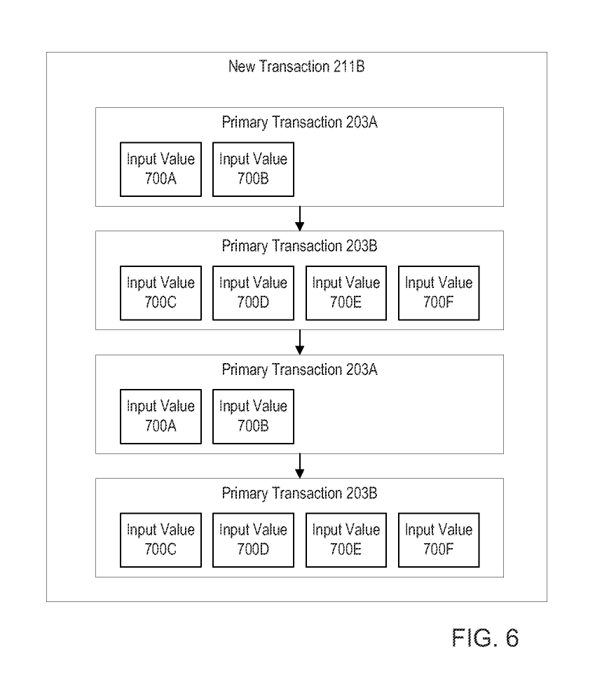

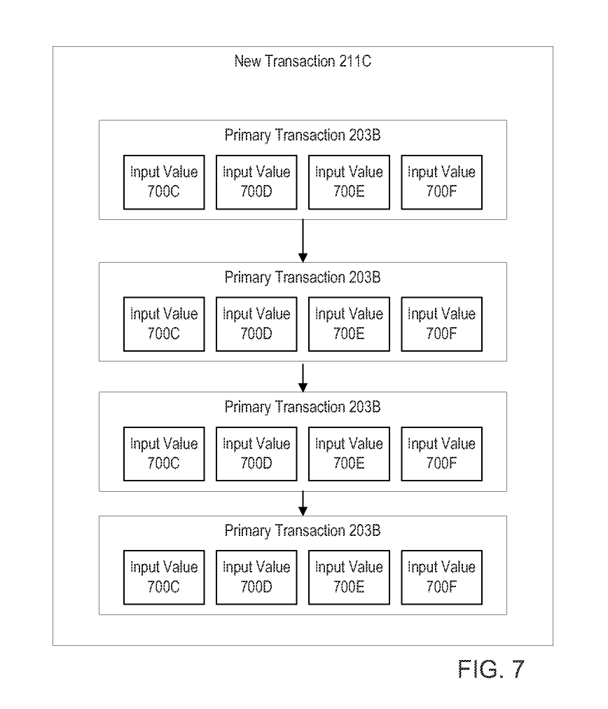

In some embodiments a new transaction may be generated so as to cause a subset of the primary transactions to be repeated multiple times. For example, FIG. 6 illustrates a new transaction 211B in which the combination of the primary transactions 203A and 203B is repeated. FIG. 7 illustrates a new transaction 211C in which the single primary transaction 203B is repeated. It may be useful to repeat a primary transaction or a combination of primary transactions for example if the simulation software 100 determines that the primary transaction(s) caused the utilization or activity level of a resource to increase. For example, if the simulation software 100 detects that a set of primary transactions cause a new element to be added to a FIFO queue in the circuit then the simulation software 100 may generate a new meta-transaction to repeat that set of primary transactions multiple times to attempt to cause the queue to become full. In this way, the test coverage of the circuit may be increased by achieving boundary conditions that maximize utilization of the circuit resources or place the resources in unusual states that might not otherwise be tested. It is noted that a new transaction may be implemented as a meta-transaction which repeats a primary transaction (or combination of primary transactions) any number of times. For example, a primary transaction may be repeated hundreds or thousands of times to check whether the circuit can correctly handle this situation.

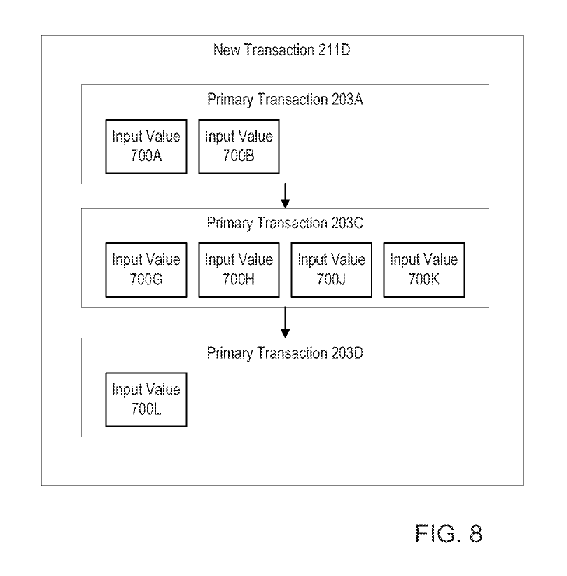

In some embodiments a new transaction may use a subset of the primary transactions, but with one or more of the primary transactions omitted. For example, FIG. 8 illustrates a new transaction 211D including the primary transactions 203A, 203C and 203D, where the primary transaction 203B has been skipped.

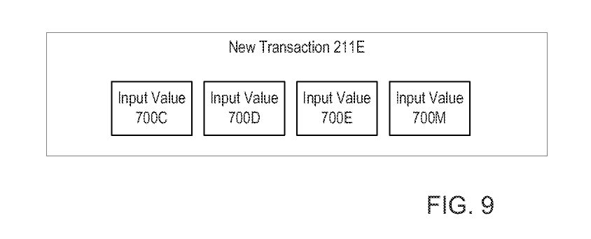

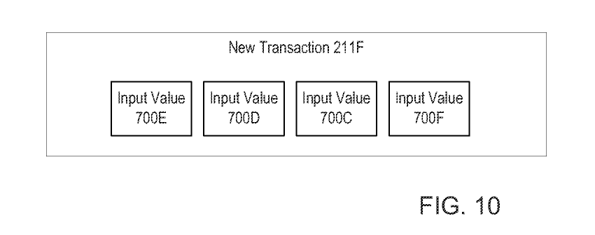

In some embodiments a new transaction may modify a primary transaction by modifying one or more of the input values used in the primary transaction. For example, FIG. 9 illustrates a new transaction 211E which is similar to the primary transaction 203B, but where the input value 700F has been replaced by a different input value 700M. For example, the new transaction 211E may cause the circuit to perform the same basic operation as the primary transaction 203B, but may use a different data value or parameter in the operation. As another example, FIG. 10 illustrates a new transaction 211F which is similar to the primary transaction 203B, where the new transaction uses the same input values 700C, 700D, 700E and 700F, but where the input values are passed in a different order than in the primary transaction 203B. For example, the input values may be passed to different input ports on the circuit.

Thus, the simulation software 100 may generate new transactions in various ways based on the primary transactions, e.g., by combining them, re-ordering them, modifying them, etc. In various embodiments the simulation software 100 may use any technique to determine how to generate the new transactions, e.g., to determine which combinations or modifications of primary transactions to use in the new transactions. Rather than simply generating random combinations or modifications of the primary transactions, the simulation software 100 may attempt to generate the new transactions in an intelligent manner, e.g., by intelligently determining new transactions that are likely to increase the test coverage of the circuit. For example, in some embodiments the simulation software 100 may use a genetic learning algorithm, a neural network algorithm, or artificial intelligence heuristic to intelligently learn which primary transactions cause notable state changes in the circuit resources and to generate new transactions based on the state changes and those particular primary transactions.

Referring again to the flowchart of FIG. 3, as indicated in block 313, the simulation software 100 may perform the automatically determined new transactions, e.g., by providing the input for the transactions to the circuit. In some embodiments the simulation software 100 may also be able to automatically determine what the correct output for the new transactions should be, and may automatically check their output against the expected output. As indicated in block 317, the simulation software 100 may measure the test coverage that has been achieved by the transactions that have been performed so far. In some embodiments the test coverage may be measured based on the circuit resource state changes that have been observed. For example, if the circuit includes a particular state machine, the simulation software 100 may have knowledge that the state machine includes several states, and may measure the test coverage for the state machine by tracking which of the states have been entered so far during the simulation. As another example, if the circuit includes a particular status bit, the simulation software 100 may measure the test coverage for the status bit based on whether it has been activated during the simulation. In some embodiments the developer or user of the simulation software 100 may configure the simulation software 100 with information specifying particular test coverage criteria that need to be met. As indicated in block 311, if the simulation software 100 determines that the test coverage goal has been met then the simulation software 100 may automatically stop the simulation. Otherwise, the above-described process of automatically generating and performing new transactions may be continued until the test coverage goal is achieved, or until a user stops the simulation.

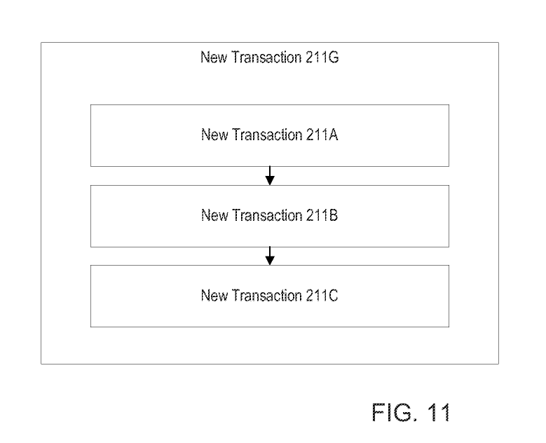

Thus, the simulation may operate to first perform the primary transactions on the circuit, and then to iteratively generate successive sets of new transactions to perform on the circuit. Each successive set of new transactions may be based on transactions that were previously generated and performed, e.g., by modifying one or more of the previous transactions. For example, FIG. 11 illustrates a new transaction 211G that combines three other new transactions 211A, 211B and 211C that may have been previously generated and performed.

The simulation software 100 may determine how to generate each successive set of new transactions by observing the effects that the previous transactions had on the resources of the circuit and attempting to create further modifications of the transactions that were successful in increasing the test coverage of the circuit. For example, the simulation software 100 may generate a first set of new transactions based on the primary transactions and perform this set of new transactions while monitoring the circuit resources. If some particular transactions in the set of new transactions were successful in further increasing the utilization or activity level of the circuit resources, the simulation software 100 may then generate additional new transactions based on those successful transactions, e.g., in an effort to push the circuit resources into deeper states of activity or utilization, or into more unusual states or boundary conditions. In successive iterations, the simulation software 100 may continue performing further modifications of the transactions in the previous iteration that were successful in increasing the utilization of the circuit resources.

On the other hand, some of the new transactions that are generated may not have any interesting effect on the circuit resources or may not cause any state changes beyond those observed for the primary transactions or previously generated new transactions. The simulation software 100 may not pursue further modifications of these transactions, or may not use them in generating further new transactions. In various embodiments the simulation software 100 may use various types of learning algorithms, neural network models, or artificial intelligence heuristics to discover how to modify previously generated transactions to gradually achieve increased test coverage of the circuit, while abandoning paths that do not lead to further test coverage.

It is noted that the flowchart of FIG. 3 illustrates the simulation method according to some particular embodiments, and numerous alternative embodiments are contemplated. It is also noted that the functions shown in the flowchart of FIG. 3 may be performed in different orders than shown, or may be performed concurrently with each other. For example, the function of monitoring the circuit resources to detect their state changes in block 305 may be performed concurrently with the function in block 301 of performing the transaction.

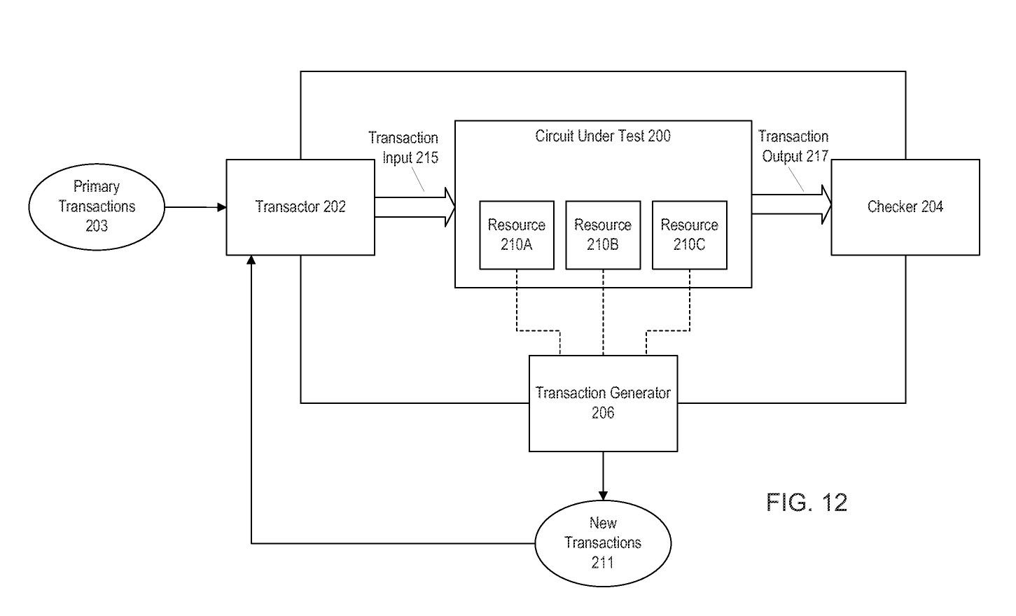

In various embodiments the simulation software 100 may have any desired software architecture. For example, the simulation software 100 may be implemented as a single program or as multiple programs that execute in conjunction with each other. In some embodiments the simulation software 100 may include multiple program modules, each of which may be implemented as one or more computer programs. FIG. 12 illustrates an example architecture of the simulation software 100 according to one embodiment. In this example the simulation software 100 includes a transactor module 202 which is configured with information specifying a set of primary transactions 203. The transactor module 202 is operable to provide the associated input values or signals for each of the primary transactions to the circuit under test 200, as shown by the transaction input 215. The circuit under test 200 uses the input to model the operation of the actual circuit and produces the transaction output 217. The checker module 204 checks the output to determine whether it is correct, and may also log the results of checking the output, e.g., to alert the circuit designer if incorrect output is produced by the circuit. The transaction generator module 206 may monitor the circuit resources 210A, 210B and 210C to detect state changes in the resources. The transaction generator module 206 may automatically generate a set of new transactions 211 and provide the new transactions to the transactor module 202. The transactor module 202 may perform the new transactions on the circuit. The transaction generator module 206 may be operable to generate multiple sets of new transactions over time, e.g., in by implementing a learning heuristic so that new transactions that achieve the test coverage goal are generated over time. The transaction generator module 206 may also determine when the test coverage goal has been reached, and may then stop the simulation.

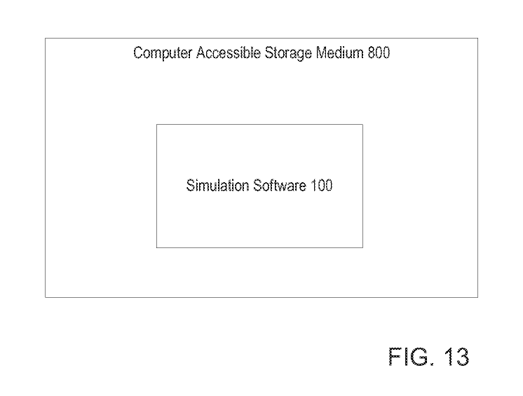

Turning now to FIG. 13, a block diagram of a computer accessible storage medium 500 is shown. The computer accessible storage medium 500 may store program instructions implementing the simulation software 100. The instructions may be executable by one or more processors to perform the functions of the simulation software 100 described above. Generally, the computer accessible storage medium 500 may store any set of instructions which, when executed, implement a portion or all of the functions described herein of the simulation software 100.

Generally speaking, a computer accessible storage medium may include any storage media accessible by a computer during use to provide instructions and/or data to the computer. For example, a computer accessible storage medium may include storage media such as magnetic or optical media, e.g., disk (fixed or removable), tape, CD-ROM, DVD-ROM, CD-R, CD-RW, DVD-R, DVD-RW, or Blu-Ray. Storage media may further include volatile or non-volatile memory media such as RAM (e.g. synchronous dynamic RAM (SDRAM), Rambus DRAM (RDRAM), static RAM (SRAM), etc.), ROM, Flash memory, non-volatile memory (e.g. Flash memory) accessible via a peripheral interface such as the Universal Serial Bus (USB) interface, a flash memory interface (FMI), a serial peripheral interface (SPI), etc. Storage media may include microelectromechanical systems (MEMS), as well as storage media accessible via a communication medium such as a network and/or a wireless link. A carrier medium may include computer accessible storage media as well as transmission media such as wired or wireless transmission.

Numerous variations and modifications will become apparent to those skilled in the art once the above disclosure is fully appreciated. It is intended that the following claims be interpreted to embrace all such variations and modifications.

What is claimed is:

1. A method comprising:
performing a simulation on a computer system to simulate operation of a circuit, wherein performing the simulation includes:
performing a first plurality of transactions on the circuit, wherein performing each transaction comprises providing respective input to the circuit;
checking output from the circuit to determine whether each of the transactions causes expected output;
monitoring one or more resources in the circuit to identify state changes of the one or more resources; and
automatically determining a plurality of new transactions to perform on the circuit, wherein each of the new transactions is determined based on the state changes of the one or more resources, wherein determining each new transaction comprises determining respective input to provide to the circuit in the new transaction.

2. The method of claim 1,
wherein the plurality of new transactions includes a first new transaction, wherein the input for the first new transaction is based on the input for one or more of the first plurality of transactions.

3. The method of claim 1,
wherein the plurality of new transactions includes a first new transaction;
wherein performing the simulation further comprises performing the first new transaction on the circuit, wherein performing the first new transaction comprises performing a combination of two or more transactions of the first plurality of transactions.

4. The method of claim 1,
wherein the plurality of new transactions includes a first new transaction;
wherein performing the simulation further comprises performing the first new transaction on the circuit, wherein performing the first new transaction comprises performing a particular transaction of the first plurality of transactions multiple times.

5. The method of claim 1,
wherein performing the first plurality of transactions on the circuit comprises performing two or more transactions on the circuit in a particular order;
wherein the plurality of new transactions includes a first new transaction;
wherein performing the simulation further comprises performing the first new transaction on the circuit, wherein performing the first new transaction comprises performing the two or more transactions of the first plurality of transactions in a different order than the particular order.

6. The method of claim 1,
wherein performing the first plurality of transactions on the circuit comprises providing two or more sets of input to the circuit in a particular order;
wherein the plurality of new transactions includes a first new transaction;
wherein performing the simulation further comprises performing the first new transaction on the circuit, wherein performing the first new transaction comprises providing the two or more sets of input to the circuit in a different order than the particular order.

7. The method of claim 1,
wherein the first plurality of transactions includes a particular transaction, wherein performing the particular transaction includes providing a set of two or more input values to the circuit;
wherein the plurality of new transactions includes a first new transaction, wherein determining the input for the first new transaction comprises generating a new set of input values by replacing one or more of the input values of the particular transaction with one or more new input values.

8. The method of claim 1,
wherein monitoring the one or more resources in the circuit to identify state changes of the one or more resources comprises monitoring the one or more resources to identify changes in utilization of the one or more resources.

9. The method of claim 8,
wherein automatically determining the plurality of new transactions to perform on the circuit comprises automatically determining a first new transaction to perform on the circuit to increase the utilization of the one or more resources.

10. The method of claim 1,
wherein monitoring the one or more resources in the circuit to identify state changes of the one or more resources comprises monitoring the one or more resources to identify a change in a particular resource from a first state to a second state;
wherein automatically determining the plurality of new transactions to perform on the circuit comprises automatically determining a first new transaction to perform on the circuit to re-create the second state of the particular resource.

11. The method of claim 1,
wherein automatically determining the plurality of new transactions comprises performing one or more of the following:
an artificial intelligence heuristic;
a genetic learning algorithm;
a neural network algorithm.

12. A method comprising:
performing a simulation on a computer system to simulate operation of a circuit, wherein performing the simulation includes:
providing a first plurality of input value sets as input to the circuit;
checking output from the circuit to determine whether each of the first plurality of input value sets causes expected output;
monitoring one or more resources in the circuit to determine state changes of the one or more resources;
automatically selecting a second plurality of input value sets to provide as input to the circuit, wherein each of the second plurality of input value sets includes a combination of two or more of the first plurality of input value sets, wherein the combination is selected based on the state changes of the one or more resources; and
providing the second plurality of input value sets as input to the circuit.

13. The method of claim 12, wherein performing the simulation further comprises:
measuring test coverage of the circuit based on the state changes of the one or more resources.

14. The method of claim 13, further comprising:
automatically stopping the simulation in response to determining that a test coverage goal has been met.

15. A computer accessible storage medium storing program instructions executable by one or more processors to:
perform a simulation to simulate operation of a circuit, wherein performing the simulation includes:
performing a first set of transactions on the circuit, wherein performing each transaction comprises providing respective input to the circuit;
checking output from the circuit to determine whether each of the transactions causes expected output;
monitoring one or more resources in the circuit to identify state changes of the one or more resources;
automatically determining a set of new transactions to perform on the circuit, wherein each of the new transactions is determined based on the state changes of the one or more resources, wherein determining each new transaction comprises determining respective input to provide to the circuit in the new transaction; and
performing the set of new transactions on the circuit, wherein performing each new transaction comprises providing the respective input determined for the new transaction to the circuit.

16. The computer accessible storage medium of claim 15,
wherein the set of new transactions includes a first new transaction;
wherein performing the simulation further comprises performing the first new transaction on the circuit, wherein performing the first new transaction comprises performing a combination of two or more transactions of the first set of transactions.

17. The computer accessible storage medium of claim 15,
wherein monitoring the one or more resources in the circuit to identify state changes of the one or more resources comprises monitoring the one or more resources to identify changes in utilization of the one or more resources;
wherein automatically determining the set of new transactions to perform on the circuit comprises automatically determining a first new transaction to perform on the circuit to increase the utilization of the one or more resources.

18. The computer accessible storage medium of claim 15, wherein monitoring the one or more resources includes one or more of:
monitoring a status bit in the circuit to determine state changes of the status bit;
monitoring a FIFO (first-in, first-out) queue in the circuit to determine state changes of the FIFO queue;
monitoring an arbiter in the circuit to determine state changes of the arbiter;
monitoring a state machine in the circuit to determine state changes of the state machine; and
monitoring a counter in the circuit to determine state changes of the counter.

19. The computer accessible storage medium of claim 15, wherein the program instructions are further executable by the one or more processors to:
iteratively generate additional sets of new transactions to perform on the circuit based on the state changes of the one or more resources, wherein generating each respective additional set of new transactions comprises:
identifying one or more previously performed transactions that were successful in increasing utilization of the one or more resources; and
modifying the one or more previously performed transactions to produce the respective additional set of new transactions.

20. A system comprising:
one or more processors; and
memory, wherein the memory stores program instructions of a transactor module, program instructions of a checker module, program instructions of a transaction generator module, and a circuit model;
wherein the program instructions of the transactor module are executable by the one or more processors to perform a first plurality of transactions on the circuit model, wherein performing each transaction comprises providing respective input to the circuit model;
wherein the program instructions of the checker module are executable by the one or more processors to check output from the circuit model to determine whether each of the transactions causes expected output;
wherein the program instructions of the transaction generator module are executable by the one or more processors to monitor one or more resources in the circuit to identify state changes of the one or more resources, and to automatically determine a plurality of new transactions to perform on the circuit model, wherein each of the new transactions is determined based on the state changes of the one or more resources, wherein determining each new transaction comprises determining respective input to provide to the circuit in the new transaction.

21. The system of claim 20,
wherein the program instructions of the transactor module are further executable by the one or more processors to perform the plurality of new transactions on the circuit, wherein performing each new transaction comprises providing the respective input determined for the new transaction to the circuit.

22. The system of claim 20,
wherein the plurality of new transactions includes a first new transaction;
wherein the program instructions of the transactor module are further executable by the one or more processors to perform the first new transaction by performing a combination of two or more transactions of the first plurality of transactions.

23. The system of claim 20,
wherein monitoring the one or more resources in the circuit to identify state changes of the one or more resources comprises monitoring the one or more resources to identify changes in utilization of the one or more resources;
wherein automatically determining the plurality of new transactions to perform on the circuit comprises automatically determining a first new transaction to perform on the circuit to increase the utilization of the one or more resources.

24. A computer accessible storage medium storing program instructions executable by one or more processors to:
perform a simulation on a computer system to simulate operation of a circuit, wherein performing the simulation includes:
performing a first plurality of transactions on the circuit;
monitoring one or more resources in the circuit to identify state changes of the one or more resources that occur in response to the first plurality of transactions;
automatically modifying the first plurality of transactions to generate a first plurality of modified transactions;
performing the first plurality of modified transactions on the circuit;
monitoring the one or more resources in the circuit to determine that a first one or more of the first plurality of modified transactions caused further state changes of the one or more resources and a second one or more of the first plurality of modified transactions did not cause further state changes of the one or more resources;
modifying the first one or more of the first plurality of modified transactions to produce a second plurality of modified transactions; and
performing the second plurality of modified transactions on the circuit.

25. The computer accessible storage medium of claim 24, wherein the program instructions are further executable to:
abandon further modifications of the second one or more of the first plurality of modified transactions in response to said determining that the second one or more of the first plurality of modified transactions did not cause further state changes of the one or more resources.
